(19) United States
(12) Patent Application Publication
(10) Pub. No.: US 2017/0046280 A1
(43) Pub. Date: Feb. 16, 2017

(54) DATA PROCESSING DEVICE AND METHOD FOR PROTECTING A DATA PROCESSING DEVICE AGAINST ATTACKS

(71) Applicant: Infineon Technologies AG, Neubiberg (DE)

(72) Inventor: Benedikt DRIESSEN, Munich (DE)

(21) Appl. No.: 15/234,018

(22) Filed: Aug. 11, 2016

(30) Foreign Application Priority Data
Aug. 14, 2015 (DE) 10 2015 113 468.3

(51) Int. Cl. G06F 12/14; G06F 21/56; G06F 21/52

(52) U.S. Cl. CPC G06F 12/1408; G06F 21/52; G06F 21/566; G06F 2212/402; G06F 2212/1052

(57) ABSTRACT

A data processing device may have an instruction memory which is configured to store a computer program, a processing unit which is configured to execute the computer program, a program counter which is configured to specify a command of the computer program in the instruction memory as the next to be executed, a call stack, an encryption device which is configured to encrypt, when a subroutine is called in the computer program, a return address which specifies a command of the computer program in the instruction memory with which operations are to continue after the execution of the subroutine, and to store the encrypted return address in the call stack and a decryption device which is configured to read, after the execution of the subroutine, the encrypted return address from the call stack, to decrypt it and to set the program counter on the basis of the decrypted return address.

### CROSS-REFERENCE TO RELATED APPLICATION

This application claims priority to German Patent Application Serial No. 10 2015 113 468.3, which was filed Aug. 14, 2015, and is incorporated herein by reference in its entirety.

### TECHNICAL FIELD

Various embodiments relate generally to data processing devices and methods for protecting a computer program against attacks.

### BACKGROUND

Data processing devices which store or process security-relevant data, such as, for example, chip cards, have to be protected against attacks. Such an attack is the overwriting of a return address during the execution of a computer program by an attacker who can as a result intervene in the program flow. Efficient mechanisms for protecting a data processing device against such attacks are desirable.

### SUMMARY

According to one embodiment, a data processing device is made available having an instruction memory which is configured to store a computer program, a processing unit which is configured to execute the computer program, a program counter which is configured to specify a command of the computer program in the instruction memory as the next to be executed, a call stack, an encryption device which is configured to encrypt, when a subroutine is called in the computer program, a return address which specifies a command of the computer program in the instruction memory with which operations are to continue after the execution of the subroutine, and to store the encrypted return address in the call stack and a decryption device which is configured to read, after the execution of the subroutine, the encrypted return address from the call stack, to decrypt it and to set the program counter on the basis of the decrypted return address.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows components of a data processing device which are involved in a subroutine call;

FIG. 2 shows a call stack;

FIG. 3 shows a data processing device according to one embodiment;

FIG. 4 shows a flowchart which illustrates a method for protecting a computer program against attacks according to one embodiment; and

FIG. 5 shows the components of a data processing device which are involved in encryption of a return address.

### DESCRIPTION

The following detailed description relates to the appended figures which show details and embodiments. These embodiments are described in such detail that a person skilled in the art can execute the invention. Other embodiments are also possible, and the embodiments can be changed in structural, logical and electrical terms without departing from the subject matter of the invention. The various embodiments are not necessarily mutually exclusive but rather various embodiments can be combined with one another with the result of producing new embodiments. Within the scope of this description, the terms “connected” and “coupled” are used to describe both a direct and an indirect connection as well as direct or indirect coupling.

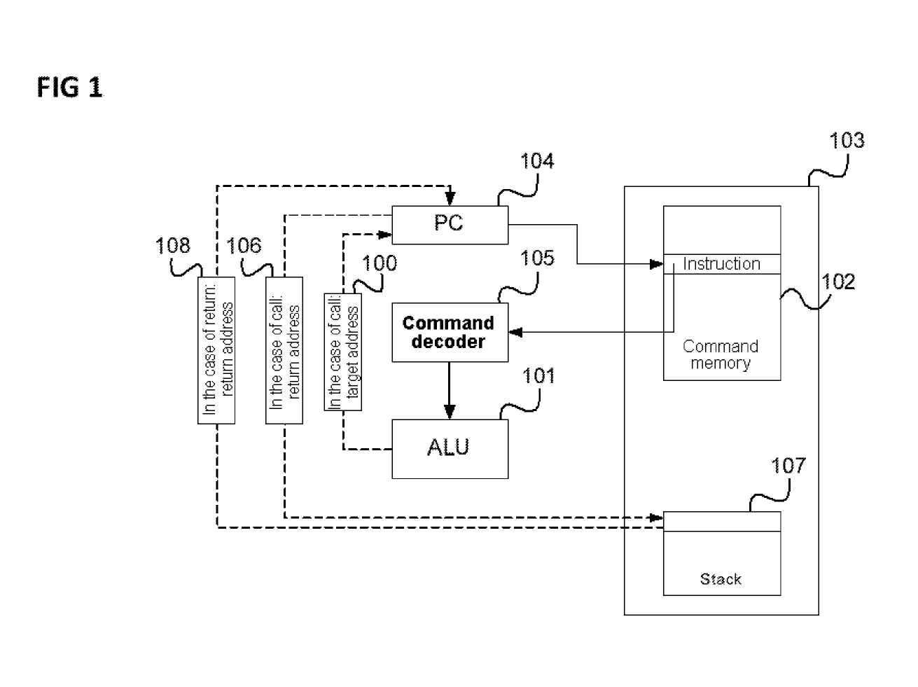

The calling of a subroutine in a program is usually carried out by means of a CALL instruction. In this context, the following address (address of the instruction after the CALL, i.e. after the execution of the subroutine, in the instruction memory) is protected as a return address in a stack memory (also referred to as a call stack or stack), (if appropriate with further register values). When the subroutine has been processed, it ends with a RETURN instruction which reads the return address from the stack and jumps to this address in the instruction memory (command memory). This is explained in more detail below with reference to FIG. 1.

FIG. 1 shows components of a data processing device 100, e.g. of a chip card module arranged on a chip card (e.g. a Smartcard), which are involved in a subroutine call.

The data processing device 100 has a processing device in the form of an ALU (Arithmetic Logic Unit) 101 which processes a computer program which is stored in an instruction memory 102, in this example part of the main memory 103 (e.g. configured as a RANI (Random Access Memory)).

A command counter 104 (also referred to as a program counter) stores for this purpose the address of the next instruction in the instruction memory to be executed, i.e. points to the next instruction to be executed. This instruction is fed to an instruction decoder 105 which converts the instruction into a form which can be interpreted by the ALU 101 and feeds it to the ALU 101. After the reading of an instruction, the command counter is correspondingly incremented in order to point to the next instruction.

If the instruction is then a CALL instruction, i.e. the call of a subroutine, the address of the command following the CALL instruction (i.e. the return address) is written into a call stack 107, in this example also implemented in the main memory 103, and instead the subroutine address of the subroutine (which determines, for example, the ALU 101) in the instruction memory is written into the command counter 104 so that the program flow continues with the subroutine.

If the subroutine finally ends (with a return instruction), the return address is read from the stack, deleted from the stack and written into the command counter, with the result that the program flow continues with the command following the CALL instruction.

The storage and loading of the addresses is performed, for example, by a corresponding controller (for example the control unit of the CPU which also contains the ALU).

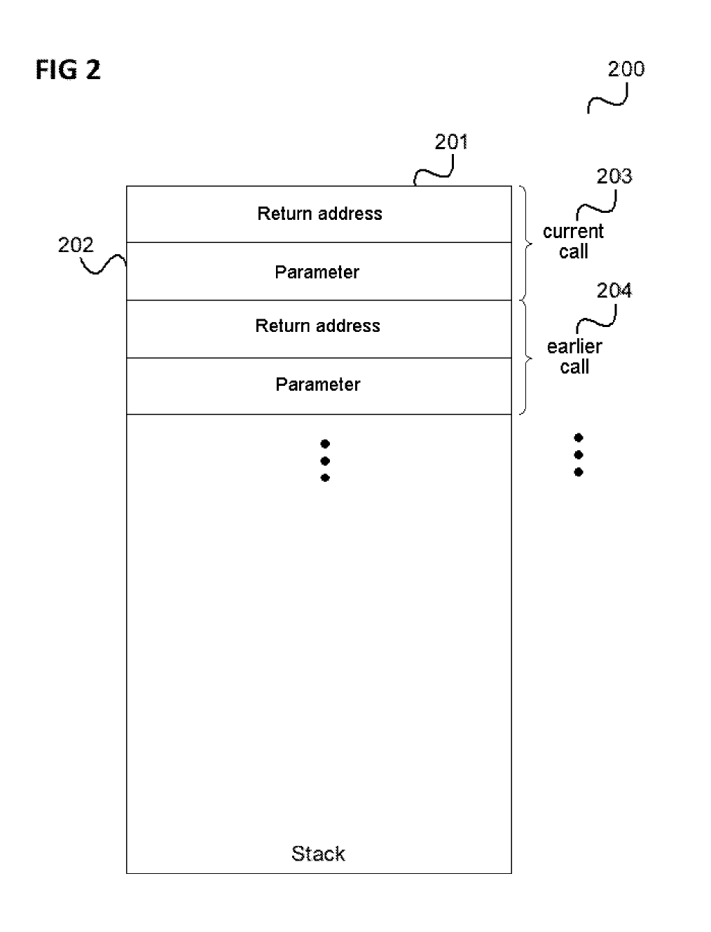

FIG. 2 shows a call stack 200 in greater detail.

The call stack (stack) 200 typically grows upward, i.e. values are stored at its upper end (push operation) and are read from its upper end (pop operation). In this example, the stack 200 contains a return address 201 right at the top. In addition to the return address 201 it is possible for further parameters (e.g. register contents) 202 which are to be used by the subroutine after the return to be stored on the stack 200. Since the calling of subroutines can be interleaved, in addition to the return address 201 and the parameters 202 for the current subroutine call 203 it is analogously possible to store return addresses and parameters for earlier subroutine calls 204, i.e. for subroutines which are not yet ended.

When the current subroutine has ended, the return address 201 is read from the stack 200 and written into the command counter 104, the further parameters 202 are read from the stack and correspondingly stored, for example in further corresponding registers of the CPU which contains the ALU and the command counter 104, and the return address 201 and the further parameters 202 are deleted from the stack 200.

In the case of a nondisrupted sequence, the program sequence is therefore continued with the instruction following the CALL instruction in the command memory 102.

However, there are attacks which can utilize program errors in the computer program by utilizing buffers in the main memory which have excessively small allocation by means of buffer overflow attacks on subroutines, in order to overwrite parts of the stack 107 with the objective of overwriting the return address 201 located there. If an attacker can reliably overwrite the return address 201 with an address which the attacker monitors, an attacker can therefore manipulate the program sequence according to his wishes once the next RETURN instruction is executed.

This type of attack is not defended against by hardware-based protection mechanisms which are directed only against hardware attacks (lasers, fitting of needles, etc.).

Approaches for defending against such an attack on a computer program which is executed by a data processing device (e.g. a chip card) are typically based on manual or partially automatized checks of the source code of the computer program and/or further software solutions, either in the compiler which is used for the computer program, or in the execution environment (runtime libraries or operating system) of the computer program to be protected.

Moreover, modifications in the compiler are not always possible (e.g. if the compiler is a supplied component) and if they are they then typically have the consequence that the generated code of the computer program grows in size, which is typically not desirable particularly in the environment of Smartcards. An example of this are “Canaries”, i.e. a random value is stored above the return address 201 on the stack 200 and is checked for integrity in the case of a RETURN instruction.

A further possible way of defending against such attacks is to audit the source code of the computer program to be protected. However, in this context it is, on the one hand, not possible to guarantee freedom from errors and, on the other hand, an audit requires specific specialist knowledge and time

Modifications of the runtime environment generally also have a cost in terms of performance or memory. In the case of the protection of a computer program which is executed by a PC, this can often be ignored, but in the case of one on a Smartcard (or generally embedded controllers) this is typically not desirable.

Approaches which are used in the processor (i.e. the CPU) itself, are typically based e.g. on marking regions on the stack 107 as non-executable. Therefore, although relatively old generation attacks can be dealt with (in which attacks attack code is also supplied directly as part of the overwriting memory area and is triggered), relatively new techniques such as “Return-Oriented Programming” (ROP) are, however, not prevented by such solutions. In the case of ROP, the attacker triggers parts of existing routines on the system which can, by definition, be executed.

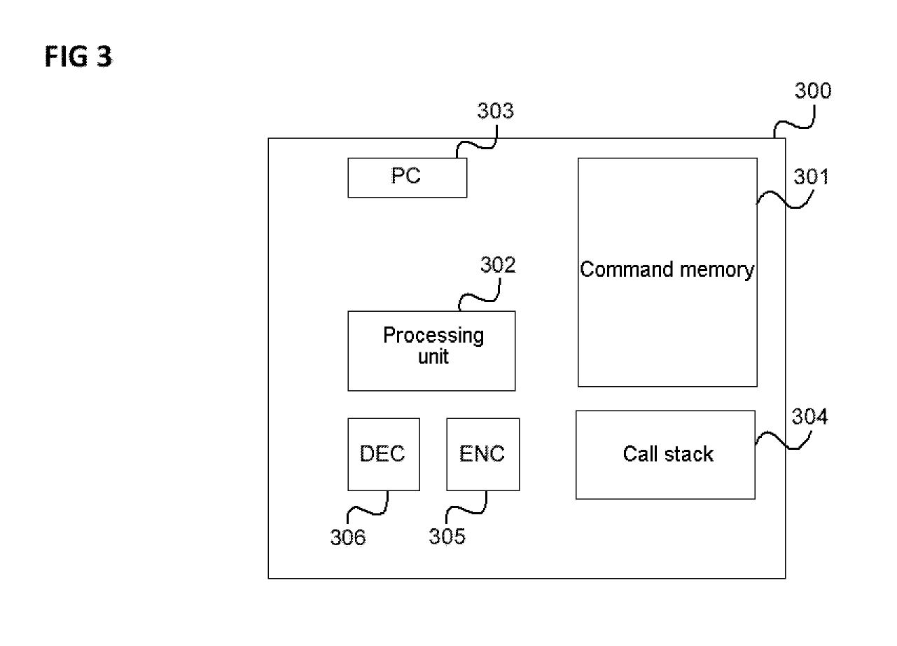

According to one embodiment, an approach is made available which is based on the encryption of a return address and is explained in more detail below with reference to FIG. 3.

FIG. 3 shows a data processing device 300 according to one embodiment.

The data processing device 300 has an instruction memory 301 which is configured to store a computer program, and a processing unit 302 which is configured to execute the computer program.

The data processing device 300 also has a program counter 303 which is configured to specify a command of the computer program in the instruction memory as the next to be executed.

Furthermore, the data processing device 300 has a call stack 304 and an encryption device 305 which is configured to encrypt, when a subroutine is called in the computer program, a return address which specifies a command of the computer program in the instruction memory 301, with which operations are to be continued after the execution of the subroutine, and to store the encrypted return address in the call stack 304.

The data processing device 300 also has a decryption device 306 which is configured to read, after the execution of the subroutine, the encrypted return address from the call stack 304, to decrypt it and to set the program counter 303 on the basis of the encrypted return address.

In other words, a return address is encrypted for a subroutine before it is stored on the call stack (stack) (for example with a block cipher with a random session key). This is done, for example when a CALL instruction for the subroutine is executed. If a corresponding RETURN instruction is executed, the value stored in the stack (value for which the encrypted return address is expected) is decrypted and triggered. A new key is used for the encryption, for example whenever the system which contains the data processing device 300 starts.

For example, a microcontroller, e.g. a 32-bit controller (e.g. with architecture as illustrated in FIG. 1) is expanded by means of three components:

1. A Random Number Generator (RNG) is provided for the generation of keys at the system start.

2. A block cipher with a block width of e.g. 32 bits is implemented. This is ideally implemented in such a way that it can perform the encryption of the return address in one clock cycle. Otherwise, the execution time of CALL instructions and RETURN instructions is increased by the corresponding execution time of the block cipher for the encryption and decryption, respectively.

3. The instruction decoder (and, if appropriate, the control logic, e.g. the control unit) of the target controller is adapted so that the processing of CALL instructions and RETURN instructions is connected to the encryption and decryption by means of the block cipher and, if appropriate, the timing of the various operations is adapted (e.g. if the execution time of CALL instructions and RETURN instructions is increased by means of the block cipher).

The expansion can be implemented solely using hardware, in a way which is transparent to the user of the data processing device. For example, a controller (such as, for example, an SC300) can be expanded at low cost (e.g. 3000 to 5000 gate equivalents).

The procedure as described with reference to FIG. 3 permits buffer overflow attacks on the stack to be defended against by virtue of the fact that it drastically reduces the predictability of a buffer overflow attack. Although an attacker can continue to use existing buffer overflows to overwrite the stack, any address which said attacker writes onto the stack instead of the actual encrypted address is mapped by the block cipher onto a value which is a random value from the point of view of an attacker who is not in possession of the key for the encryption. This random value is triggered when the computer program is executed and gives rise to a result which cannot be predicted by the attacker. In a processing device (e.g. a microcontroller or chip card module) which is protected in this way, buffer overflow attacks lose value, since an attacker can then use them only for denial of service attacks.

The use of an encryption permits an attack on a faulty computer program to be defended against in which values can be read from the stack (e.g. by means of format string errors). If, in the case of such an attack, e.g. only an XOR combination of the return address (instead of encryption) with a session key is used, the attacker can determine the session key from the value read from the stack (by also determining the return address from the program sequence) and can therefore then calculate the correct value of the address which he would like to store on the stack. In other words, according to one embodiment, encryption can be understood to be a secure method in the sense that the key cannot be determined from an encrypted value together with the unencrypted value (at least not without excessively high effort)—which is in contrast with a simple XOR combination. For example the encryption is cryptographically strong encryption.

The components of the data processing device (e.g. the processing unit, the encryption device and the decryption device) can be implemented by means of one or more circuits. In one embodiment, a “circuit” is understood to be any unit which implements a logic and which can be hardware, software, firmware or a combination thereof It is therefore possible for a “circuit” in one embodiment to be a hard-wired logic circuit or a programmable logic circuit such as, for example, a programmable processor, e.g. a microprocessor. A “circuit” can also be understood to be a processor which executes software. A “circuit” can be understood to be any type of implementation of the functions described below in an embodiment.

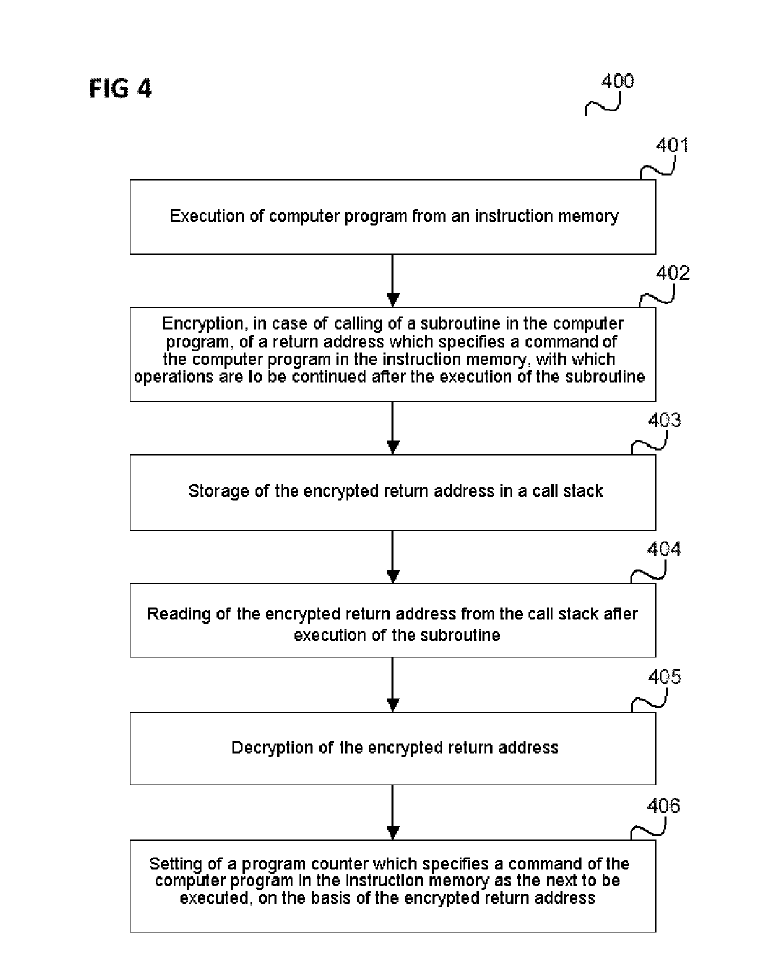

The data processing device executes, for example, a method such as is illustrated in FIG. 4.

FIG. 4 shows a flowchart 400 which illustrates a method for protecting a data processing device against attacks.

At 401, a data processing device executes a computer program from an instruction memory.

At 402, a return address which specifies a command of the computer program in the instruction memory, with which operations are to be continued after the execution of the subroutine, is encrypted when a subroutine in the computer program is called.

At 403, the encrypted return address is stored in a call stack.

At 404, after the execution of the subroutine, the encrypted return address is read from the call stack.

At 405, the encrypted return address (read from the stack) is decrypted.

At 406, a program counter of the data processing device, which counter specifies a command of the computer program in the instruction memory as the next to be executed is set on the basis of the decrypted return address (e.g. the decrypted return address is written in).

In the text which follows, various embodiments are specified.

Embodiment 1 is a data processing device such as is illustrated in FIG. 3.

Embodiment 2 is a data processing device according to embodiment 1, wherein the encryption device is configured to encrypt the return address by means of block encryption, and the decryption device is configured to decrypt the encrypted return address in accordance with the block encryption.

Embodiment 3 is a data processing device according to embodiment 1 or 2, wherein the processing unit is an ALU.

Embodiment 4 is a data processing device according to one of embodiments 1 to 3, having a CPU which has the processing unit, the program counter, the encryption device and the decryption device.

Embodiment 5 is a data processing device according to one of the embodiments 1 to 4, having a key generator which is configured to generate a cryptographic key, wherein the encryption device is configured to encrypt the return address by means of the cryptographic key.

Embodiment 6 is a data processing device according to embodiment 5, wherein the encryption device is configured to encrypt, for each of a plurality of subroutine calls, the respective return address by means of the same cryptographic key.

Embodiment 7 is a data processing device according to embodiment 5 or 6, wherein the key generator is configured to generate the cryptographic key when the data processing device is started.

Embodiment 8 is a data processing device according to one of embodiments 1 to 7, wherein the encryption device is configured to encrypt the return address by means of a permutation substitution network.

Embodiment 9 is a data processing device according to one of embodiments 1 to 8, wherein the encryption device is configured to encrypt, for a command which is to be currently executed, the address of the command following the current command in the instruction memory and, if the command which is to be currently executed is a subroutine call, to store the encrypted address as an encrypted return address in the call stack.

Embodiment 10 is a data processing device according to embodiment 9, wherein the encryption device is configured to encrypt, for a command which is to be currently executed, the address of the command following the current command in the instruction memory, irrespective of whether the command which is to be currently executed is a subroutine call.

Embodiment 11 is a data processing device according to one of embodiments 1 to 10, wherein the data processing device is a chip card module of a chip card.

Embodiment 12 is a method for protecting a computer program against attacks as illustrated in FIG. 4.

It is to be noted that any described embodiment can be combined with any other described embodiment.

Embodiments are described in greater detail below.

According to one embodiment, the encryption device 305 encrypts the return address whenever a CALL instruction occurs, that is to say in other words on request. However, in this case delays in the program execution owing to the execution duration of the encryption (e.g. of the code) can occur.

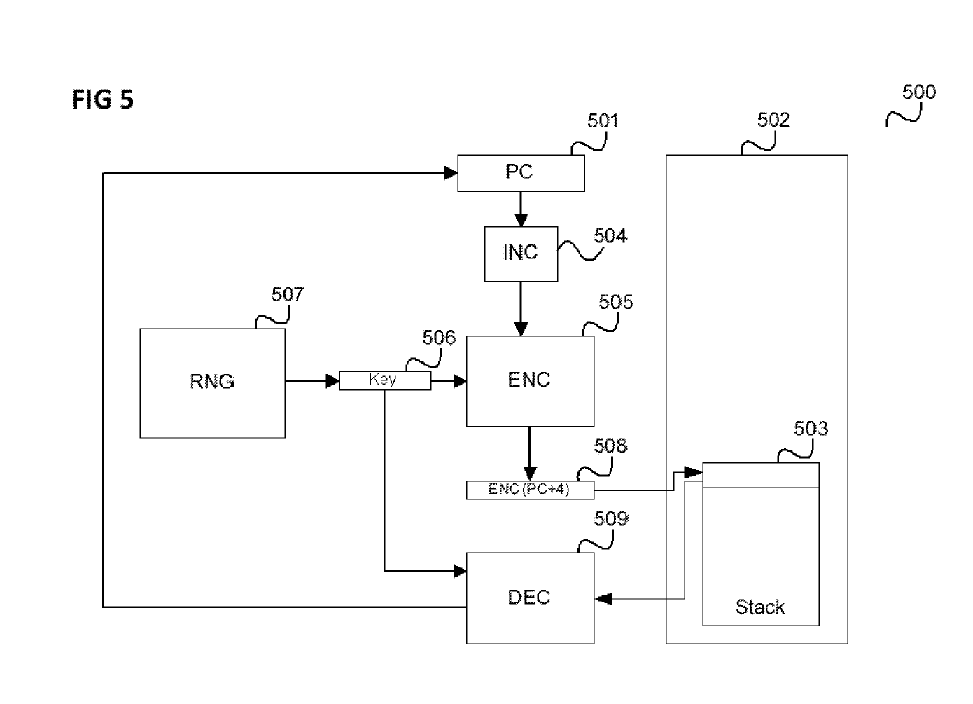

Alternatively to this, the following address, i.e. the address of the instruction following the instruction in the instruction memory 301 can be encrypted at the cost of the power consumption, in every (command) clock pulse, i.e. for every instruction which is executed. A corresponding embodiment is illustrated in FIG. 5.

FIG. 5 shows the components of a data processing device 500 which are involved in encryption of a return address.

The data processing device 500 has a command counter 501 and a call stack 503 which is provided in a main memory 502, which are used, for example, as described with reference to FIG. 1 and FIG. 2.

In this embodiment, the address of the instruction which follows in the instruction memory, that is to say the command counter value which is generated after incrementation of the command counter by an incrementer 504 (for example, after a reading of an instruction from the instruction memory, the incrementer 504 increments the command counter by four, i.e. the incrementer generates the address PC+4) is adopted as the return address.

The data processing device has an encryption device 505 which, at the start of the data processing device, receives a random key 506 (for example 128 bit) from a random number generator 507, and by means of this key encrypts the address generated by the incrementer 504. The next command address is clearly encrypted speculatively.

The encryption device implements, for example, a block cipher in an SPN (Substitution Permutation Network) designed with a number of rounds (for example eight) which are sufficient to achieve a desired level of security against crypto-analytical attacks.

In the event of the current instruction being a CALL, the encryption device 505 places the encrypted address 508 directly on the stack 503.

For the RETURN instruction, such a trade-off between power consumption and speed of execution is, for example, not made but instead the encrypted return address value which is actually to be used is read from the stack 503, decrypted by a decryption device 509 and written into the command counter 501, since speculative reading is very costly. The decryption device 509 also receives the key 506 and carries out decryption, corresponding to the encryption by means of the encryption device 505. The encryption device 505 and the decryption device 509 can be implemented, for example, by the same crypto unit.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A data processing device, comprising:
an instruction memory which is configured to store a computer program;
a processing unit which is configured to execute the computer program;
a program counter which is configured to specify a command of the computer program in the instruction memory as the next to be executed;
a call stack;
an encryption device which is configured to encrypt, when a subroutine is called in the computer program, a return address which specifies a command of the computer program in the instruction memory with which operations are to be continued after the execution of the subroutine, and to store the encrypted return address in the call stack;
a decryption device which is configured to read, after the execution of the subroutine, the encrypted return address from the call stack, to decrypt it and to set the program counter on the basis of the decrypted return address.

2. The data processing device of claim 1,
wherein the encryption device is configured to encrypt the return address by means of block encryption, and the decryption device is configured to decrypt the encrypted return address in accordance with the block encryption.

3. The data processing device of claim 1,
wherein the processing unit is an Arithmetic Logic Unit.

4. The data processing device of claim 1, further comprising:
a Central Processing Unit which has the processing unit, the program counter, the encryption device and the decryption device.

5. The data processing device of claim 1, further comprising:
a key generator which is configured to generate a cryptographic key;
wherein the encryption device is configured to encrypt the return address by means of the cryptographic key.

6. The data processing device of claim 5,
wherein the encryption device is configured to encrypt, for each of a plurality of subroutine calls, the respective return address by means of the same cryptographic key.

7. The data processing device of claim 5,
wherein the key generator is configured to generate the cryptographic key when the data processing device is started.

8. The data processing device of claim 1,
wherein the encryption device is configured to encrypt the return address by means of a permutation substitution network.

9. The data processing device of claim 1,
wherein the encryption device is configured to encrypt, for a command which is to be currently executed, the address of the command following the current command in the instruction memory and, if the command which is to be currently executed is a subroutine call, to store the encrypted address as an encrypted return address in the call stack.

10. The data processing device of claim 9,
wherein the encryption device is configured to encrypt, for a command which is to be currently executed, the address of the command following the current command in the instruction memory, irrespective of whether the command which is to be currently executed is a subroutine call.

11. The data processing device of claim 1,
wherein the data processing device is a chip card module of a chip card.

12. A method for protecting a data processing device against attacks, the method comprising:
executing a computer program from an instruction memory by means of a data processing device;
encrypting, when a subroutine is called in the computer program, a return address which specifies a command of the computer program in the instruction memory with which operations are to be continued after the execution of the subroutine;
storing the encrypted return address in a call stack;
reading the encrypted return address from the call stack after the execution of the subroutine;
decrypting the encrypted return address;
setting a program counter of the data processing device which specifies a command of the computer program in the instruction memory as the next to be executed, on the basis of the decrypted return address.

13. The method of claim 12,
wherein the encrypting comprises encrypting the return address by means of block encryption, and the decryption device is configured to decrypt the encrypted return address in accordance with the block encryption.

14. The method of claim 12, further comprising:
generating a cryptographic key;
wherein the encrypting comprises encrypting the return address by means of the cryptographic key.

15. The method of claim 14,
wherein the encrypting comprises encrypting, for each of a plurality of subroutine calls, the respective return address by means of the same cryptographic key.

16. The method of claim 14,
wherein the cryptographic key is generated when the data processing device is started.

17. The method of claim 12,
wherein the encrypting comprises encrypting the return address by means of a permutation substitution network.

18. The method of claim 12,
wherein the encrypting comprises encrypting, for a command which is to be currently executed, the address of the command following the current command in the instruction memory and, if the command which is to be currently executed is a subroutine call, storing the encrypted address as an encrypted return address in the call stack.

19. The method of claim 18,
wherein the encrypting comprises encrypting, for a command which is to be currently executed, the address of the command following the current command in the instruction memory, irrespective of whether the command which is to be currently executed is a subroutine call.

20. The method of claim 12,
wherein the data processing device is a chip card module of a chip card.
